(19) United States
(12) Patent Application Publication
(10) Pub. No.: US 2002/0126918 A1
(43) Pub. Date: Sep. 12, 2002

(54) Apparatus and method for interacting with printed materials

(76) Inventor: Ernesto Solis, Jalisco (MX)

Correspondence Address: HEWLETT-PACKARD COMPANY, Intellectual Property Administration, P.O. Box 272400, Fort Collins, CO, 80527-2400, US

(21) Appl. No.: 09/802,502

(22) Filed: Mar. 8, 2001

(51) Int. Cl. G06K 9/54; G06K 9/60

(52) U.S. Cl. 382/306

(57) ABSTRACT

An apparatus for interacting with printed material includes machine readable code added to printed material. The machine readable code is directed to additional information related to printed material. A scanner for reading the machine readable code is connected to an electronic appliance for retrieving and displaying the additional information. The electronic appliance is connected to a local information source/database or a remote information source/database, such as the Internet. The Internet, for example, contains the additional information to which machine readable code points. In a preferred embodiment, a printer is connected to the electronic appliance so that additional information may be retrieved and reviewed. In another preferred embodiment, audio information is accessed thereby enhancing the interactive nature of Braille books and/or hard and soft cover books.

### FIELD OF THE INVENTION

This invention relates to an apparatus and method for interacting with printed materials. In particular, the invention relates to an apparatus and method for interacting with printed materials utilizing machine readable code added to the printed material. More particularly, the invention relates to an apparatus and method for interacting with printed materials through local or remote databases/information sources, such as the Internet, utilizing machine readable code that is directed to the databases containing additional information related to the machine readable code.

### BACKGROUND OF THE INVENTION

The growth of computer information storage capacity and the advent of the Internet has opened enormous volumes of information for use by individuals throughout the globe. Further, the volume of information grows with each passing day. Likewise, every day sees more and more people accessing computer databases and/or connecting to the Internet. It is not an overstatement to say that computers and the Internet are literally changing the world and the way people and businesses interact with each other.

Nonetheless, old ways of doing business and communicating will not disappear and will continue to be a critical means of transferring information. Businesses, for example, will continue to utilize printed “flyers” to introduce people to their goods and services. Individuals, likewise will continue to access information by means of hard copies of books, magazines, and so forth. In some situations, it is unlikely that hard copies will ever be fully replaced by electronic media. For example, sight impaired individuals will continue to read books using Braille.

In the situations where these “traditional” forms of communicating are utilized, there is a need in the art for providing access to additional information contained either locally or remotely, for example, on the Internet, so that the volumes of material related to the information contained on the traditional medium may be retrieved and reviewed.

Thus, there is a need in the art for providing an apparatus and method for interacting with printed material locally and remotely. It, therefore, is an object of this invention to provide an apparatus and method for interacting with printed material locally and remotely, for example, through the Internet, whereby additional information may be accessed.

### SUMMARY OF THE INVENTION

Accordingly, the apparatus for interacting with printed material includes machine readable code, directed to additional information, added to printed material. A scanner for reading the machine readable code is connected to an electronic appliance for retrieving and displaying the additional information from local or remote information sources. The electronic appliance is connected to a local or remote information database, such as the Internet, which contains the additional information related to the machine readable code. In a preferred embodiment, a printer is connected to the electronic appliance. In further preferred embodiments, the machine readable code is in the form of optical characters, the additional information is an Internet URL, the scanner is a pencil scanner, and the electronic appliance is a multimedia PC.

In a further preferred embodiment, the printed material is business advertising flyers. In another preferred embodiment, the printed material is a book and the invention further includes a copyright clearing software application connected to the electronic appliance. In yet another preferred embodiment, the printed material is in Braille and the machine readable code is directed to a local or remote audio file. In this embodiment, the audio file is selected from a group including audio Internet URL's and local audio files contained on the electronic appliance.

In a still further embodiment, in an Internet environment, computer program code recorded on a computer readable media for interacting with printed material includes a first computer program code for reading the machine readable code, directed to additional information, where the machine readable code is added to the printed material. A second computer program code is provided for retrieving and displaying information from a local or remote information source. The first and second computer program codes are linked to an electronic appliance connected to the local or remote information sources, such as the Internet. The Internet, for example, contains the additional information related to the machine readable code. In a preferred embodiment, a third computer program code for copyright clearing is linked to the electronic appliance as well. In a still further preferred embodiment, computer program code for accessing local and/or remote audio files is provided.

In yet another preferred embodiment, a method for interacting with printed material through local or remote databases includes the steps of adding machine readable code, directed to additional information, to the printed material. A scanner, for reading the machine readable code, is connected to an electronic appliance and the electronic appliance is conformed to retrieve and display information from local or remote information sources. The electronic appliance is connected to the local or remote information sources, such as the Internet, and the local/remote information source contains additional information related to the machine readable code. Finally, the machine readable code is scanned, and the additional, related, information is retrieved, displayed and reviewed.

In a preferred embodiment of the method, a further step includes connecting a printer to the electronic appliance. In still further embodiments, the machine readable code directs the user to an Internet URL, the code is added to a group including advertising flyers and books, and a copyright clearing software application is added to the electronic appliance. In other preferred embodiments, machine readable code is added to Braille books and an audio software application and a copyright clearing software application are added to the electronic appliance. In another preferred embodiment, machine readable code is added to one of a group including educational books, history books, interactive novels, and music books. In such a case, the preferred embodiment includes adding a copyright clearing software application to the electronic appliance.

### BRIEF DESCRIPTION OF THE DRAWINGS

Other objects, features, and advantages of the present invention will become more fully apparent from the following detailed description of the preferred embodiments, the appended claims and the accompanying drawings in which:

FIG. 1 is a schematic diagram of a preferred embodiment of the apparatus for interacting with printed material of the present invention;

FIG. 2 is an illustration of a Braille book of the invention of FIG. 1; and

FIG. 3 is an illustration of a standard printed book of the invention of FIG. 1; and

FIG. 4 is a flow diagram of a preferred embodiment of the method for interacting with printed material of the present invention.

### DETAILED DESCRIPTION OF THE PREFERRED EMBODIMENT

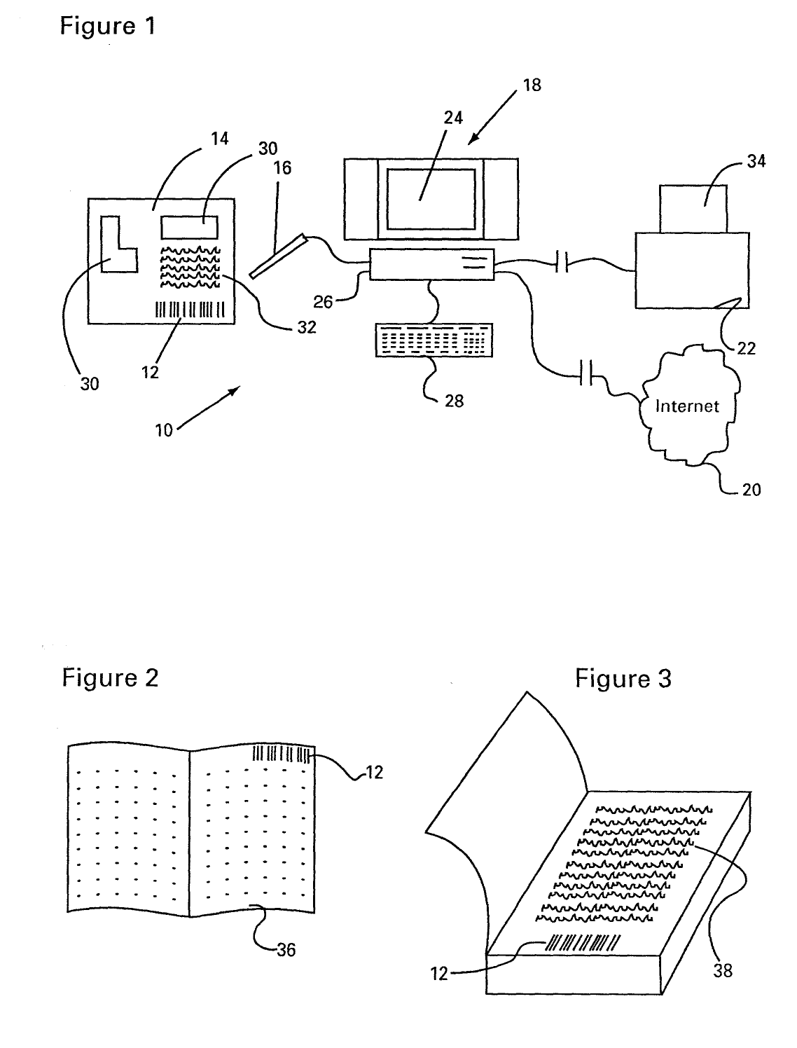

The preferred embodiment of the present invention are illustrated by way of example in FIGS. 1-4. With specific reference to FIG. 1, an apparatus for interacting with printed material 10 of the present invention includes machine readable code 12 added to printed material 14. A scanner 16 is provided for reading machine readable code 12. Scanner 16 is connected to an electronic appliance 18 and electronic appliance 18 is connected to a local database/information source or a remote database/information source, such as the Internet 20, containing additional information related to printed material 10. In a preferred embodiment, electronic appliance 18 is connected to printer 22. Electronic appliance 18 is any electronic appliance now known or hereafter developed for connection to a local or a remote database/information source including, but not limited to, a multimedia PC including monitor 24, CPU 26 and input devices 28, such as a keyboard and mouse for example.

In a preferred embodiment, printed material 14 comprises a business advertisement, such as a flyer with pictures 30 and written copy 32. In this embodiment, a business creates the flyer with pictures 30 and written copy 32 and then adds machine readable code 12 to the flyer. The machine readable code 12 is directed to additional information related to the printed material 14. For the purposes of this invention, the term “directed to” is meant to disclose any means by which a source of additional information is identified. In a preferred embodiment, the additional information is identified by means of an Internet URL. Certainly, any means now known or hereafter developed for pointing/directing/identifying the desired additional information is within the scope of this invention.

As illustrated in FIG. 1, printed material 14 includes machine readable code 12 added at any desired location on printed material 14. In a preferred embodiment, machine readable code 12 is in the form of optical characters. Optical characters are preferred since their use is widespread and commonplace. Additionally, machines for reading optical characters are plentiful and inexpensive. Once again, any means now known or hereafter developed for creating code which directs a user to additional information is appropriate.

Scanner 16 likewise is considered to be any scanner now known or hereafter developed which is capable of interpreting machine readable code 12. As illustrated in FIG. 1, scanner 16 is connected to electronic appliance 18 so that information obtained by scanner 16, from machine readable code 12 is transferred to electronic appliance 18. Electronic appliance 18 then utilizes the information from machine readable code 12 in accessing the additional information to which machine readable code 12 is directed. Once again, machine readable code 12, in a preferred embodiment, includes an Internet URL. Electronic appliance 18 accesses the particular Internet URL to which machine readable code 12 is directed. At that point, in a preferred embodiment, electronic appliance 18 either automatically or, under the direction of a user as is known in the art, retrieves the additional information and displays it for a user's consideration.

By way of illustration, in a preferred embodiment, printed material 14 is a business advertisement in the nature of a flyer/promotional advertisement/coupon. Machine readable code 12 in the form of optical characters that can be scanned by scanner 16 are added to printed material 14. Scanner 16, such as a handheld/pencil scanner, USB or serial connected to electronic appliance 18, for example, reads machine readable code 12. Electronic appliance 18 is connected to the local or remote database such as Internet 20 by any means known in the art. Once electronic appliance 18 locates the additional information to which it was directed by machine readable code 12, electronic appliance 18 enables many additional user interfaces with the additional information related to printed material 14. That is to say, electronic appliance 18 may display more information about a specific product advertised in printed material 14 (flyer/brochure/etc.), including directing a user to the manufacturer's web site, for example. In such a case, automatic ordering (e-commerce) of a promoted product is enabled. Additionally, invention 10 enables interaction with printed material 14 by enabling the printing of the additional information in the form of discount coupons 34, for example, by means of printer 22. Still further, once an electronic connection is made through electronic appliance 18 to the additional information to which machine readable code 12 is directed, a user may be automatically reimbursed (into the user's checking account or account with the manufacturer) for discounts/savings.

Referring now to FIG. 2, the apparatus for interacting with printed material 14 of the present invention 10 is shown in a preferred embodiment of the invention in conjunction with Braille book 36. In this embodiment, invention 10 extends the capabilities of Braille book 36 so as to effectively make it an interactive or multimedia book. The essentials of invention 10 as previously described for business use above are the same. That is to say, machine readable code 12 is added to Braille book 36 as illustrated. Machine readable code 12 contains code, which, after being scanned by scanner 16 and sent to electronic appliance 18, directs a user to particular additional information related to the Braille book 36. In a preferred embodiment, a user is directed to a remote audio URL on Internet 20 or a local audio file on electronic appliance 18. As a result, vision impaired readers of Braille books 36, by way of invention 10, are provided with a much more interactive/multimedia reading experience.

The audio file on electronic appliance 18 may take any form now known or hereafter developed, such as CD or DVD media for example. In another embodiment, a copyright clearing software application is linked to electronic appliance 18 so as to ensure that the legal requirements for playing audio files are met.

Referring now to FIG. 3, printed material 14 in the form of a hard and/or softcover book 38 is disclosed. Once again, in accordance with the general intent of the present invention, the apparatus for interacting with printed material also applies to the field of traditional books. As discussed above with regard to advertising media and the use of Braille books 36, hard and/or softcover books 38 are printed with machine readable code 12. The machine readable code 12 contains code that points to specific additional information, through specific Internet URL's, for example, or local files, including audio/video files, contained on CD/DVD devices on electronic appliance 18, for example. Once again, pen scanner/clicking device 16 is utilized to read machine readable code 12 and send that information to electronic appliance 18. Electronic appliance 18 is connected to Internet 20, for example, and retrieves the additional information for presentation to a user.

As is obvious to persons of ordinary skill, invention 10 has many important useful applications for traditional books including educational books, history books, interactive novels, and music books for example. In a preferred embodiment, a copyright clearing application is linked to electronic appliance 18 so as to safely play audio and/or display visual information as previously discussed.

By way of example, a portable wireless scanner 16 reads machine readable code 12 and transmits the information to a central electronic appliance 18 that downloads the requested information from a local or remote source, like the Internet 20. Such information is then played back as an audio file on a central or specific audio system connected to the electronic appliance. Further, the information could also be displayed in the form of video on a video screen or web TV.

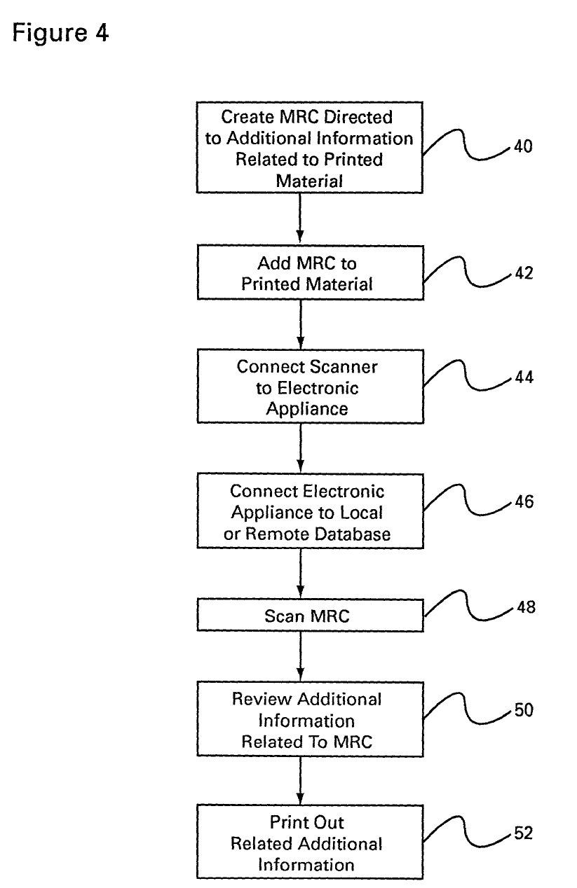

Referring now to FIG. 4, a method for interacting with printed material 14 through a local database or a remote database, such as Internet 20, is disclosed. To begin with, machine readable code 12 is created so as to direct a user to additional information in step 40. At step 42, machine readable code 12 is added to printed material 14. Scanner 16 is connected to electronic appliance 18 at step 44 and electronic appliance 18 is connected to the local or remote database, such as the Internet 20, at step 46. Thereafter scanner 16 is utilized to scan machine readable code 12 into electronic appliance 18 at step 48. A user then reviews selected additional information obtained by electronic appliance 18 as directed by machine readable code 12 related to that particular machine readable code 12 in step 50. In a preferred embodiment, information from the remote source, as selected by the user for example, is printed out on printer 22 in step 52.

In operation, the apparatus 10 for interacting with printed material 14 through the Internet 20, for example, includes machine readable code 12 which is directed to, and/or points a user to, additional information related to printed material 14. For the purposes of this invention, it is to be understood that what is meant by “additional information” is information on a separate, local or remote, database considered relevant to the printed material 14 on which the machine readable code 12 is added. Further, the additional information is remote in the sense that it is accessed on a separate local database or a remote database such as the Internet 20, and is not contained directly on printed material 14. Still further, the additional information may be relevant in a general or a specific way. That is, for example, if the printed material 14 is a business flyer for tennis shoes, the machine readable code 12 may direct a user to additional information concerning sporting goods in general or to a particular brand of tennis shoe.

Scanner 16 reads machine readable code 12 and electronically transfers that information to electronic appliance 18. Electronic appliance 18 is connected to the local or remote information source for retrieving and displaying information. As directed by machine readable code 12 through the scanner 16 interface, electronic appliance 18 retrieves the particular additional information from the Internet 20, for example. In a preferred embodiment, again, a printer 22 is connected to electronic appliance 18 further enhancing the interactive nature of the invention so that selected additional information maybe printed out.

In the instance where the printed material 14 is in the form of a business flyer, i.e. a business promotional advertisement, printer 22 may be utilized by the business and the user alike for printing out the relevant additional information. The additional relevant information, again, can take any desired form such as a discount coupon, for example.

In the instance where the printed material 14 is in the form of a Braille book 36, the additional information most likely will take the form of audio files. It is within the scope of the invention for the additional information to be printed in Braille on hard copy. In this instance, machine readable code 12 may direct electronic appliance 18 to a remote audio URL on the Internet 20 or to a local audio file on CPU 26 in the form of a CD or DVD media device. As appropriate, as in the case where the machine readable code 12 directs electronic appliance 18 to additional information protected by copyright laws, copyright clearing software is connected/linked to electronic appliance 18.

In a preferred embodiment, the present invention is embodied in a computer program and recorded on a computer readable medium for interacting with printed material 14 on a local or remote information source/database. In this embodiment, first computer program code is provided for reading machine readable code 12 added to the printed material 14. The first computer program code interprets the machine readable code 12 and discerns the additional information to which the machine readable code 12 is directed. A second computer program code is provided for retrieving and displaying the additional information. The first and second computer program codes are linked to electronic appliance 18 which in turn is linked to the local information source/database or a remote information source/database, such as Internet 20. Internet 20, containing the previously described huge volumes of information, includes the additional information related to the particular machine readable code 12. In a preferred embodiment, a third computer program code is provided for copyright clearing and is linked to the electronic appliance 18. Still further, in a preferred embodiment, computer program code is provided for accessing audio files.

While the present invention has been disclosed in connection with the preferred embodiments thereof, it will be understood that there may be other embodiments which fall within the spirit and scope of the invention as defined by the following claims.

What is claimed is:

1. An apparatus for interacting with printed material comprising:
(a) machine readable code, directed to additional information, added to said printed material;
(b) a scanner for reading said machine readable code connected to an electronic appliance for retrieving and displaying said additional information; and
(c) the electronic appliance connected to a local or remote information source with the additional information related to said machine readable code.

2. The apparatus of claim 1 further comprising a printer connected to said electronic appliance.

3. The apparatus of claim 1 wherein said machine readable code is in the form of optical characters.

4. The apparatus of claim 1 wherein said remote information source is an Internet URL.

5. The apparatus of claim 1 wherein said scanner is a pencil scanner.

6. The apparatus of claim 1 wherein said electronic appliance is a multimedia PC.

7. The apparatus of claim 1 wherein said printed material is advertising flyers.

8. The apparatus of claim 1 wherein said printed material is a book and further comprising a copyright clearing application connected to said electronic appliance.

9. The apparatus of claim 1 wherein said printed material is in Braille and wherein said machine readable code is directed to an audio file.

10. The apparatus of claim 9 wherein said audio file is selected from a group including remote audio Internet URL's and local audio files on said electronic appliance.

11. Computer program code recorded on a computer readable medium for interacting with printed material, comprising:
(a) first computer program code for reading machine readable code, directed to additional information related to the printed material, where said machine readable code is added to said printed material;
(b) second computer program code for retrieving and displaying the additional information; and
(c) said first and second computer program code linked to an electronic appliance connected to a local or remote information source containing the additional information related to said machine readable code.

12. The invention of claim 11 further comprising a third computer program code for copyright clearing linked to said electronic appliance.

13. The invention of claim 11 further comprising computer program code for accessing audio files.

14. A method for interacting with printed material comprising the steps of:
(a) adding machine readable code directed to additional information related to said printed material;
(b) connecting a scanner for reading said machine readable code to an electronic appliance and conforming said electronic appliance to retrieve and display the additional information;
(c) connecting said electronic appliance to a local or remote information source containing the additional information related to said machine readable code; and
(d) scanning said machine readable code and reviewing said additional information as displayed on said electronic appliance.

15. The method of claim 14 further comprising the step of connecting a printer to said electronic appliance.

16. The method of claim 14 wherein the step of adding machine readable code further comprises the step of adding machine readable code directed to an Internet URL.

17. The method of claim 14 further comprising the steps of adding machine readable code to one of a group including advertising flyers and books and adding a copyright clearing application to said electronic appliance.

18. The method of claim 14 further comprising the steps of adding machine readable code to Braille books and adding an audio application and a copyright clearing application to said electronic appliance.

19. The method of claim 14 wherein the step of adding machine readable code further comprises the step of adding machine readable code to one of a group including educational books, history books, interactive novels, and music books.

20. The method of claim 19 further comprising the step of adding a copyright clearing application to said electronic appliance.
